(19) United States
(12) Patent Application Publication
(10) Pub. No.: US 2026/0118797 A1
(43) Pub. Date: Apr. 30, 2026

(54) OPTICAL SCANNING DEVICE

(71) Applicant: Sharp Kabushiki Kaisha, Sakai City (JP)

(72) Inventors: Akito TERAMOTO, Sakai City (JP); Hidenori SATO, Sakai City (JP)

(21) Appl. No.: 19/363,801

(22) Filed: Oct. 21, 2025

(30) Foreign Application Priority Data
Oct. 31, 2024 (JP) 2024-191542

(51) Int. Cl. G03G 15/043; B41J 2/44; B41J 2/47; G02B 26/12; G03G 15/04

(52) U.S. Cl. CPC G03G 15/0435; B41J 2/44; B41J 2/471; G02B 26/125; G03G 15/04036

(57) ABSTRACT

The optical scanning device comprises a light source, a polygon mirror 15, an fθ lens 19, and a BD sensor. The fθ lens is configured such that the region emitting light from the light source to expose the surface of the photosensitive body and the region emitting light from the light source to reach the BD sensor are continuous.

The light emitted from the light source discharges static electricity from areas outside both ends of the actual printing region in the main scanning direction on the photosensitive surface.

The fθ lens includes: a first region that transmits light reaching the actual printing region; a second region provided at both longitudinal ends of the first region; and a third region provided at both longitudinal ends of the second region. The light reaching the BD sensor from the polygon mirror is configured to pass through the third region.

### CROSS-REFERENCE TO RELATED APPLICATION

The present application claims priority from Japanese Application JP2024-191542, the content of which is hereby incorporated by reference into this application.

### BACKGROUND OF THE INVENTION

### 1. Field of the Invention

The disclosure relates to an optical scanning device of an image forming apparatus.

### 2. Description of the Related Art

As an optical scanning device (Laser Scanner Unit (LSU)) of an image forming apparatus in the related art, there is an optical scanning device that includes a light source driving device that keeps a light intensity of a light source constant, a light amount adjusting device that continuously changes a transmittance of a beam, and a detecting device that detects a density of an image, and is configured to make a beam intensity variable according to output of the detecting device, so that a beam having a desired output intensity can be radiated onto a surface of a photoreceptor.

The optical scanning device of the image forming apparatus in the related art that makes a beam intensity variable was configured as described above. In the related art, the light intensity of the light source was variable, but there was no configuration or idea for thereby neutralizing charge in a specific region. Further, a light amount at a front or a rear of the optical scanning device was lower than that at a center, and there was a problem that laser charge neutralization could not be performed over an entire width of the photoreceptor.

### SUMMARY OF THE INVENTION

The disclosure has been made to address the above-described issue, and an object of the disclosure is to provide an optical scanning device that enables laser charge neutralization over an entire width of a photoreceptor.

### Solution to Problem

An optical scanning device according to the disclosure includes a light source that emits light to expose a surface of a photoreceptor, a polygon mirror that deflects light from the light source in a main scanning direction, an fθ lens provided on an optical path from the polygon mirror to the photoreceptor, a BD sensor, and one or more controllers that control light emission of the light source, wherein the fθ lens is configured such that a region where light to expose the surface of the photoreceptor is emitted from the light source and a region where light reaching the BD sensor is emitted from the light source are continuous, charge outside an actual printing region at each of both ends in the main scanning direction of the actual printing region of the surface of the photoreceptor is neutralized with the light emitted from the light source, the fθ lens includes a first region that transmits light reaching the actual printing region, a second region provided at each of both end portions in a longitudinal direction of the first region, and a third region provided in the longitudinal direction on an outside of the second region, and the light reaching the BD sensor from the polygon mirror is configured to pass through the third region.

Preferably, the one or more controllers perform control such that, during charge neutralization, a light amount of light passing through the first region is decreased, a light amount of light passing through the second region is increased, and light reaching the surface of the photoreceptor has a light amount equal to or greater than a charge neutralization level regardless of a path taken.

It is preferable that a plurality of the fθ lenses be disposed symmetrically about a main scanning direction component including a rotation axis of the polygon mirror and that each fθ lens have an identical shape.

### Advantageous Effects of Disclosure

According to the disclosure, light from a polygon mirror neutralizes charge not only in a printing region but also in a region outside the printing region that reaches a BD sensor.

As a result, it is possible to provide an optical scanning device that enables laser charge neutralization over an entire width of a photoreceptor.

The above-described objects, other objects, features, and advantages of the disclosure will be further obvious from the detailed description of examples given below with reference to the drawings.

### BRIEF DESCRIPTION OF THE DRAWINGS

FIG. 1 is a plan view illustrating an optical scanning device of an image forming apparatus according to an embodiment of the disclosure.

FIG. 2 is a diagram illustrating a first region to a third region continuously formed on an fθ lens illustrated in FIG. 1, and a controller that controls light emission of four semiconductor lasers that irradiate the first region to the third region.

FIG. 3 includes a graph showing the first region to the third region of the fθ lens illustrated in FIG. 2 and a light amount distribution of the regions, and a diagram illustrating a region requiring charge neutralization.

### DETAILED DESCRIPTION OF THE INVENTION

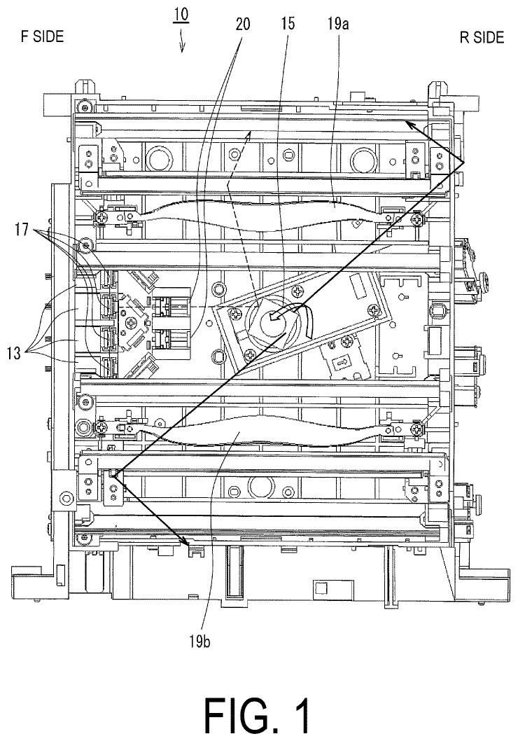

An embodiment according to the disclosure will be described in detail below with reference to the drawings. FIG. 1 is a plan view illustrating an optical scanning device of an image forming apparatus according to the embodiment of the disclosure. In FIG. 1, a left side is a front (F) side of the image forming apparatus, and a right side is a rear (R) side of the image forming apparatus.

Referring to FIG. 1, an optical scanning device 10 includes a semiconductor laser 13 that is a light source that is provided on the F side and emits light to expose a surface of a photoreceptor (not illustrated), a polygon mirror 15 that is provided at a center and deflects light from the semiconductor laser 13 in a main scanning direction, and a cylindrical lens 20 that is disposed between the semiconductor laser 13 and the polygon mirror 15, deflects the light from the semiconductor laser 13 in a sub-scanning direction, and irradiates the polygon mirror 15.

Here, four of the semiconductor lasers 13 are provided so as to correspond to respective colors of YMCK, light emitted from the semiconductor laser 13 is collimated by a collimator lens 17 provided for each semiconductor laser 13, and is condensed on the photoreceptor (not illustrated) by the cylindrical lens 20 being a convex lens via the polygon mirror 15 and two fθ lenses 19a and 19b, thereby writing data.

Note that in FIG. 1, a path is indicated by a dotted line along which light from one semiconductor laser 13 is collimated by the collimator lens 17 and guided to the photoreceptor (not illustrated) via the cylindrical lens 20, and through the polygon mirror 15 and the fθ lens 19a. As illustrated in FIG. 1, the light is deflected by a mirror (not illustrated) after passing through the fθ lens 19a.

In addition, in FIG. 1, a thick arrow indicates a rotation direction of the polygon mirror 15, and a thick line indicates a path from the polygon mirror 15 to the photoreceptor (not illustrated). Here, a reason why the paths indicated by the thick lines are folded back after passing through the two fθ lenses 19a and 19b is that light passing through a BD sensor described below is folded back by a folding mirror (not illustrated).

The polygon mirror 15 is rotated by a polygon motor provided at a lower portion of the polygon mirror 15, and scans the light from the semiconductor laser 13. Here, a point on the polygon mirror 15 and a point on the photoreceptor are arranged so as to have a conjugate relationship, and thus even when the rotary shaft of the polygon motor is slightly inclined, influence thereof is not exerted on the photoreceptor.

The cylindrical lens 20 has a curvature only in a vertical direction on an incident surface side, and is flat on an exit surface side.

### First Embodiment

Note that the fθ lenses 19a and 19b are disposed symmetrically about a main scanning direction component including the rotation axis of the polygon mirror 15, and the fθ lenses 19a and 19b have an identical shape.

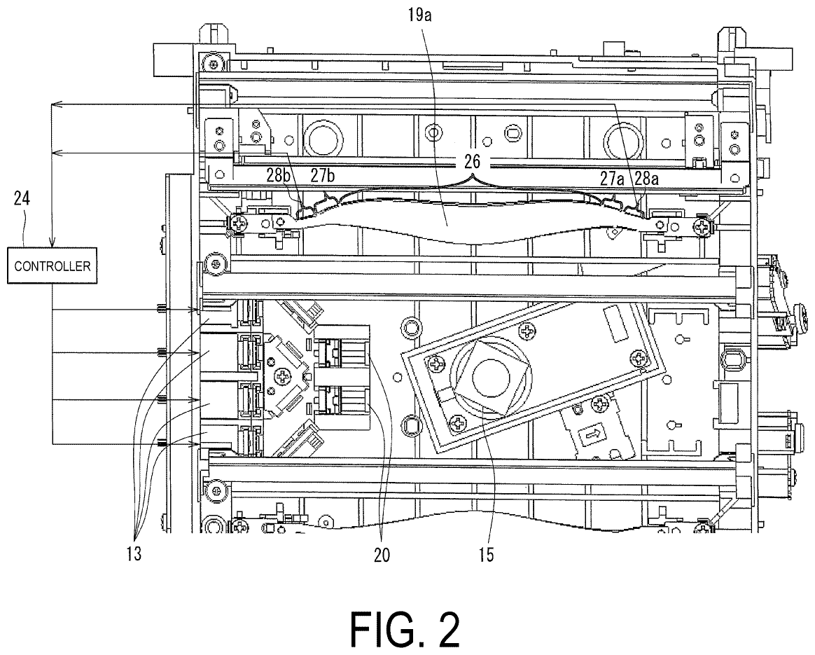

Next, a path of the light from the semiconductor laser 13 from the fθ lens 19a on one side illustrated in FIG. 1 to the photoreceptor (not illustrated) will be described. FIG. 2 is a diagram illustrating a first region 26 to third regions 28a and 28b continuously formed on the fθ lens 19a illustrated in FIG. 1, and a controller 24 that controls light emission of the four semiconductor lasers 13 that irradiate the first region 26 to the third regions 28a and 28b. The fθ lens 19a includes the first region 26 provided at a central portion thereof, second regions 27a and 27b provided at both end portions in a longitudinal direction of the first region 26, and the third regions 28a and 28b provided outside the second regions 27a and 27b in the longitudinal direction. Here, the first region 26 is a printing region, and the second regions 27a and 27b are outside the printing region. The third regions 28a and 28b are each a region through which light from the polygon mirror 15 reaches the BD sensor (not illustrated). That is, the BD sensors are provided in the third region 28a on a right side and the third region 28b on a left side in FIG. 2, and are sensors that detect image writing timing. When light enters the BD sensor provided in the third region 28b on the left side, writing of an image at a new surface of the polygon mirror 15 is started. That is, the light to the BD sensor does not enter an image plane of the photoreceptor but the BD sensor immediately after the fθ lens 19a, and ends.

### Second Embodiment

Note that when signals indicating that the BD sensors (not illustrated) provided in the third regions 28a and 28b receive light are input to the controller 24, the controller 24, during charge neutralization, decreases a light amount of light passing through the first region 26, increases light amounts of light passing through the second regions 27a and 27b, and controls the semiconductor laser 13 so that light from a light source of the semiconductor laser 13 reaching the surface of the photoreceptor (not illustrated) has a light amount equal to or greater than a charge neutralization level regardless of a path taken.

In order to illustrate such signal flows, FIG. 2 illustrates input of signals from the third regions 28a and 28b to the controller 24 and output of signals to the semiconductor lasers 13.

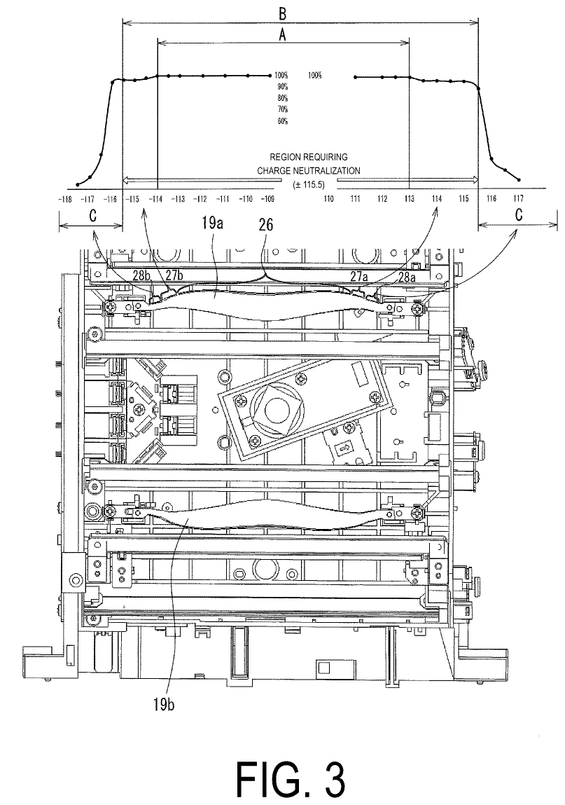

FIG. 3 includes a graph showing the first region to the third regions of the fθ lens 19a illustrated in FIG. 2 and a light amount distribution of the regions, and a diagram illustrating a region requiring charge neutralization. In FIG. 3, distances (+ and − numerical values) to both end portions of the fθ lens 19a when a center of the fθ lens 19a is defined as 0 are illustrated below a horizontal axis. Further, a vertical axis represents intensity of laser light from the semiconductor laser 13 as a light amount distribution in %.

As illustrated in FIG. 3, the region requiring charge neutralization is a region of ±115.5 on the horizontal axis, and is indicated by a width indicated by an arrow B in FIG. 3. Further, referring to the vertical axis, the intensity of laser light in this range is substantially 100%. A region of a width indicated by an arrow A narrower than the above region is a printing region indicated as the first region 26 in FIG. 2. Further, regions indicated by arrows C further outside the region indicated by the arrow B in FIG. 3 correspond to the third regions 28a and 28b in FIG. 2.

On the other hand, the region indicated by the arrow B in the drawing is a region where an exposure width on the photoreceptor (not illustrated) is further widened by applying a light amount shading correction. Here, the light amount shading correction means a correction for increasing a light amount of laser light even in a region other than a printing region of a photoreceptor that is unnecessary for printing in the related art, thereby enabling laser charge neutralization.

Next, a relationship between the first region 26 to the third regions 28a and 28b illustrated in FIG. 2 and the regions indicated by the arrow A and the arrow B illustrated in FIG. 3 will be described. The first region 26 illustrated in FIG. 2 corresponds to the region A illustrated in FIG. 3, the second regions 27a and 27b illustrated in FIG. 2 correspond to regions obtained by excluding the region indicated by the arrow A from the region indicated by the arrow B illustrated in FIG. 3, and the third regions 28a and 28b illustrated in FIG. 2 correspond to horizontal portions formed outside the region indicated by the arrow B illustrated in FIG. 3 and portions indicated by the arrows C where the light amount distribution drops from the horizontal portions.

In this manner, by controlling the laser light from the semiconductor laser 13 by the controller 24, the intensity of the laser light can be maintained at a high value in the region indicated by the arrow B that is wider than the region indicated by the arrow A. As a result, the intensity of the laser light can be maintained at 100% in a range wider than the region requiring charge neutralization (the region indicated by the arrow B), and charge neutralization by the laser light is enabled in an entire region of the photoreceptor (not illustrated).

The disclosure may be carried out in other various forms without departing from the spirit or essential characteristics thereof. Thus, the above embodiments are merely examples and should not be interpreted as limiting. All modifications and changes equivalent in scope with the claims of the disclosure are included in the scope of the disclosure.

According to the disclosure, an optical scanning device that enables laser charge neutralization over an entire width of a photoreceptor can be provided, and thus the disclosure is useful as an optical scanning device.

1. An optical scanning device, comprising:
a light source that emits light to expose a surface of a photoreceptor;
a polygon mirror that deflects light from the light source in a main scanning direction;
an fθ lens provided on an optical path from the polygon mirror to the photoreceptor;
a BD sensor; and
one or more controllers that control light emission of the light source, wherein
the fθ lens is provided such that a region where light to expose the surface of the photoreceptor is emitted from the light source and a region where light reaching the BD sensor is emitted from the light source are continuous,
charge outside an actual printing region at each of both ends in the main scanning direction of the actual printing region of the surface of the photoreceptor is neutralized with the light emitted from the light source,
the fθ lens includes a first region that transmits light reaching the actual printing region, a second region provided at each of both end portions in a longitudinal direction of the first region, and a third region provided in the longitudinal direction on an outside of the second region, and
the light reaching the BD sensor from the polygon mirror passes through the third region.

2. The optical scanning device according to claim 1, wherein
the one or more controllers perform control such that, during charge neutralization, a light amount of light passing through the first region is decreased, a light amount of light passing through the second region is increased, and light reaching the surface of the photoreceptor has a light amount equal to or greater than a charge neutralization level regardless of a path taken.

3. The optical scanning device according to claim 1, wherein
a plurality of the fθ lenses are disposed symmetrically about a main scanning direction component including a rotation axis of the polygon mirror, and each of the plurality of fθ lenses has an identical shape.
